(19) United States
(12) Patent Application Publication
(10) Pub. No.: US 2026/0037839 A1
(43) Pub. Date: Feb. 5, 2026

(54) MANAGING POLICY DEFINITION FOR DATA PROCESSING SYSTEMS USING REPRESENTATIONS OF INFERENCE MODEL PREDICTIONS

(71) Applicant: Dell Products L.P., Round Rock, TX (US)

(72) Inventors: OFIR EZRIELEV, Be'er Sheva (IL); HANNA YEHUDA, Acton, MA (US); YONIT LOPATINSKI, Shomria (IL)

(21) Appl. No.: 18/788,489

(22) Filed: Jul. 30, 2024

(51) Int. Cl. G06N 5/04; G06N 7/01; H04L 41/0894

(52) U.S. Cl. CPC G06N 5/04; G06N 7/01; H04L 41/0894

(57) ABSTRACT

Methods and systems for managing operation of a data processing system are disclosed. To manage the operation, a plurality of predictions using at least one inference model trained to predict future states for the data processing system over time may be obtained. A statistical characterization regarding agreement in the plurality of predictions may be obtained. The statistical characterization and the plurality of predictions may be used to obtain an acyclic graph for use in analyzing the predicted future states. Based on analysis of the acyclic graph, a policy defining the operation of the data processing system may be defined, and a computer-implemented service may be provided using the data processing system in accordance with the policy.

### FIELD

Embodiments disclosed herein relate generally to managing operation of data processing systems. More particularly, embodiments disclosed herein relate to systems and methods to manage policy definition for the data processing systems using representations of inference model predictions.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2C show diagrams illustrating data flows in accordance with an embodiment.

FIG. 3 shows an example of a representation of inference model predictions in accordance with an embodiment.

FIG. 4 shows a flow diagram illustrating a method in accordance with an embodiment.

FIG. 5 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing system may provide computer-implemented services while in an operational state. Over time, operational states of the data processing system may change due to occurrences of events for the data processing system. For example, states (e.g., operational states) for the data processing system may be defined based on a manner in which the data processing system is expected to operate with respect to events such as component failures (e.g., hardware and/or software components of the data processing system), an introduction of new components to the data processing system that may reduce (or improve) operational efficiency and/or functionality of the data processing system, changes in environmental factors (e.g., changes in external conditions for the data processing system, such as operating environment temperatures, power source availability, etc.), and/or other types of events or conditions that may result in changes to a current operational state of the data processing system. For example, the occurrences of such events may affect the availability of resources (e.g., external resources, hardware/software components of a data processing system) used to provide the computer-implemented services.

To manage changes in operation of the data processing system, an inference model may be used to run a simulation (e.g., generate a prediction, based on ingest data) regarding a future state for the data processing system over time. For example, the inference model may predict future events for the data processing system, based on the ingest data. The predicted future events may be used to define predicted future states for the data processing system over time.

Policies for the data processing system that are keyed to the predicted future states may be identified (e.g., from a set of existing policies and/or new policies may be created in view of the predicted future states) and invoked in order to manage undesired outcomes of the predicted future states. For example, a policy for the data processing system may define how the data processing system is to operate while in the predicted future state (e.g., to manage outcomes associated with the predicted future state), thereby indicating a manner in which the resources of the data processing system are to be distributed and/or otherwise accounted for so that the computer-implemented services may continue to be provided.

However, the prediction obtained using the inference model may be unreliable and/or may otherwise not meet needs of a downstream consumer of the prediction (e.g., due to the inference model being biased or limited, and/or due to information included in the ingest data). Additionally, the prediction may include stochastic elements (e.g., random variance in one or more parameters of the inference model over time) which may introduce a degree of variability in predictions generated by the inference model. As a result, a policy may be selected based on an unreliable prediction thereby causing the resources used to provide the computer-implemented services to be unavailable and/or inappropriately distributed.

To improve the reliability of predictions of future states for the data processing system, a plurality of predictions of future states for the data processing system may be generated using at least one inference model. For example, the inference model(s) may be prompted to run a simulation (e.g., using same or similar ingest data) multiple times in order to generate the plurality of predictions. The inference model(s) may predict occurrences of future states that differ from one another to varying degrees. Therefore, to assess agreement in the plurality of predictions, the plurality of predictions may be analyzed using statistical methods to obtain a statistical characterization of the plurality of predictions (e.g., ratios, means, medians, modes, and/or standard deviations).

The inference model(s) may predict multiple future states for the data processing system over time, some of which may be dependent on one another. For example, a likelihood of an occurrence of a state may be dependent on occurrences of any number of preceding states. Therefore, as a result of running a plurality of simulations to generate such predictions, the inference model(s) may generate large volumes of complex (e.g., interrelated, partially dependent) data.

However, these large volumes of complex data may be difficult to analyze and/or interpret (e.g., by a subject matter expert (SME)), which may hinder proactive policy management for the data processing system. This may result in delays and/or improper response to predicted future states, and in turn, the computer-implemented services provided by the data processing system may be interrupted, delayed, and/or of a reduced quality.

Therefore, to improve a likelihood of providing desired computer-implemented services, the plurality of predictions may be represented using an acyclic graph. The acyclic graph may be defined based on statistical characterizations of the predictions. The acyclic graph may provide for visual interpretation of a reduced size representation of the large volumes of complex data. For example, the acyclic graph may include nodes representing clusters of predicted future states, connected by edges representing likelihoods of transitions between the clusters over time. A user (e.g., an SME) or other entity may interact with the acyclic graph to manage policy definition for the data processing system.

Thus, embodiments disclosed herein may address, among other technical problems, the technical challenge of proactive policy management for a data processing system based on a plurality of predicted future states for the data processing system. By using an acyclic graph to represent the predicted future states and statistical characterizations thereof, context and clarity regarding future states that are predicted to occur in a series over time (e.g., streams of future states) may be introduced to improve policy management. Policies for the data processing system may be managed (e.g., defined, updated) in accordance with likely predicted future states, and remedial actions may be performed based on the policies to increase a likelihood of the computer-implemented services being provided to downstream consumers of the services as desired.

In an embodiment, a method for managing operation of a data processing system is provided. The method may include: obtaining a plurality of predictions using at least one inference model trained to predict future states for the data processing system over time; obtaining a statistical characterization regarding agreement in the plurality of predictions; obtaining an acyclic graph, based at least on the plurality of predictions and the statistical characterization; defining a policy based on an analysis of the acyclic graph, the policy defining how the data processing system is to operate; and, providing a computer-implemented service using the data processing system in accordance with the policy.

Obtaining the acyclic graph may include defining time partitions for the acyclic graph, and, for each time partition of the time partitions, defining clusters of predicted future states based, in part, on the statistical characterization and criteria including requirements corresponding to quantities of the statistical characterization. The acyclic graph may include a plurality of nodes connected by a plurality of edges, the plurality of nodes representing the clusters of the predicted future states, the plurality of edges representing relationships between the clusters, and the relationships indicating likelihoods of transitions between occurrences of the predicted future states of the clusters over the time partitions.

The acyclic graph may define streams, the streams including the clusters of the predicted future states that are predicted to occur in a series over time, and each stream of the streams including an upstream cluster and a downstream cluster, the downstream cluster being predicted to occur after the upstream cluster occurs. An occurrence of the downstream cluster may be dependent on an occurrence of the upstream cluster.

Defining the policy may include: identifying a first downstream cluster of a first stream of the acyclic graph, the first downstream cluster being associated with an undesired future outcome for the data processing system; identifying a first upstream cluster of the first stream; and, populating the policy so that a likelihood of an occurrence of predicted future states of the first upstream cluster is reduced while the policy is enforced.

Defining the policy may include: identifying a second downstream cluster of a second stream of the acyclic graph, the second downstream cluster being associated with a desired future outcome for the data processing system; identifying a second upstream cluster of the second stream; and, populating the policy so that a likelihood of an occurrence of predicted future states of the second downstream cluster is not reduced while the policy is enforced.

The statistical characterization may include at least one quantity selected from a group consisting of a ratio, a mean, a median, a mode, and a standard deviation.

Defining the policy may include: obtaining, using the acyclic graph, a graphical user interface illustrating streams of predicted future states, the streams indicating where different streams converge and diverge, and likelihoods of the streams occurring; presenting the graphical user interface to a user to obtain user input; and, populating the policy using at least the user input.

The user input may be responsive to at least one prompting by the graphical user interface, the prompting indicating that at least one of the streams would violate an operational goal for the data processing system.

A non-transitory media may include instructions that when executed by a processor cause the computer-implemented method to be performed.

A data processing system may include the non-transitory media and a processor, and may perform the computer-implemented method when the computer instructions are executed by the processor.

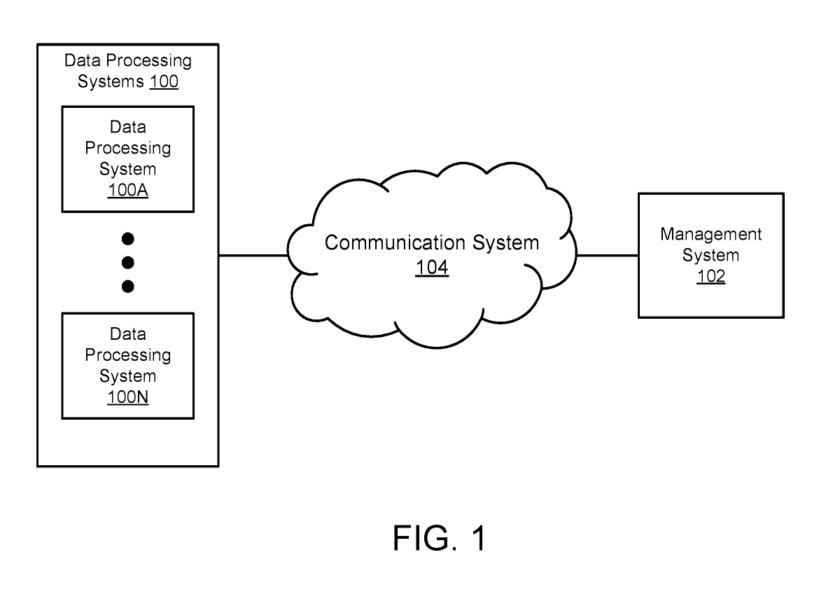

Turning to FIG. 1, a block diagram illustrating a system in accordance with an embodiment is shown. The system shown in FIG. 1 may provide for management of data processing systems that may provide, at least in part, computer-implemented services. The computer-implemented services may include any type and quantity of services including, for example, data services (e.g., data storage, generation, access and/or control services), communication services (e.g., instant messaging services, video-conferencing services), and/or any other type of service that may be implemented with a computing device. The computer-implemented services may be provided by, for example, data processing systems 100, management system 102, and/or any other type of devices (not shown in FIG. 1). Other types of computer-implemented services may be provided by the system shown in FIG. 1 without departing from embodiments disclosed herein.

The system may include any number and/or type of data processing systems 100 (e.g., 100A-100N). Data processing systems 100 may include any number of hardware components (e.g., processors, memory modules, storage devices, communications devices). The hardware components may support execution of any number and type of applications (e.g., software components). Changes in available functionalities of the hardware and/or software components may provide for various types of different computer-implemented services to be provided over time.

The computer-implemented services may be provided in accordance with policies for data processing systems 100. For example, a policy may define actions for managing operation of any of data processing systems 100 and/or may be triggered when any of data processing systems 100 enter an operational state keyed to the policy. The policies may be defined and invoked to achieve operational goals for data processing systems 100.

For example, data processing systems 100 may include robotic entities such as unmanned aerial vehicles (e.g., drones) used to provide agriculture management services. To provide the agriculture management services, the drones may be deployed to a geographic location (e.g., a field used to produce crops) to spray portions of the field with pesticide in accordance with policies for the drones. For example, to ensure a desired coverage of the field with pesticide, the policies may define specific numbers of drones to be deployed at specific times (e.g., under specific circumstances).

To proactively manage operation of data processing systems 100 in view of the operational goals, an inference model may be used to generate predictions based on ingest data regarding occurrences of future states that may impact provision of the computer-implemented services (e.g., performance data of components of the data processing systems, sensor data collected by the data processing systems, observational weather data collected by doppler radar, radiosondes, weather satellites, buoys, etc.). At least a portion of the states may be interpreted as events (e.g., weather events and/or other events which may impact the operation of data processing systems 100).

However, predictions obtained using the inference model may be unreliable for proactively managing operation of data processing systems 100. For example, the inference model may be unable to generate predictions that meet the needs of a downstream consumer of the inferences (e.g., predictions, simulations) due to poor training or validation processes, poor training data quality, and/or for other reasons. Additionally, the predictions may include stochastic elements (e.g., random variance in one or more parameters over time) which may result in prediction variability. Prediction variability may reduce a reliability of using the predictions as a basis for making decisions.

Returning to the above example, the inference model may predict that a weather event is unlikely to adversely impact an ability of the drones to perform the agriculture management services (e.g., based on any criteria for degrees of likelihood). If the prediction is inaccurate (e.g., if the weather event adversely impacts the ability of the drones to spray pesticide as desired during and/or following the weather event), then the computer-implemented agriculture management services may be of a reduced quality, interrupted, and/or delayed.

Therefore, to reduce the effects of prediction variability, a plurality of predictions regarding occurrences of future states for data processing systems 100 may be generated. The plurality of predictions may be generated by performing multiple simulations using at least one inference model. The simulations may be run by providing same or similar ingest data to the inference model(s) in multiple instances. When more than one inference model is used, the inference models may be of varying types and/or sizes, and the inference models may be trained using differing training datasets and/or optimization algorithms.

The plurality of predictions obtained using the inference model(s) may be statistically analyzed to obtain a statistical characterization indicating agreement in the plurality of predictions. The statistical characterization, input data for the inference model(s), and/or the plurality of predictions may be utilized to obtain a policy for updating operation of data processing systems 100 thereby accounting for variability in the plurality of predictions.

However, the plurality of predictions and any statistical analysis thereof may be difficult to analyze and/or interpret for decision-making purposes due to the plurality of predictions occupying a large volume of complex data (e.g., complexity due to a dependent nature of portions of the plurality of predictions). For example, some occurrences of the predicted future states may be dependent on one another and may contribute to streams of predicted future states (e.g., sequences of dependent states that occur over time and/or as a result of one another). This may result in large amounts of complex time dependent data that may be difficult to analyze and/or interpret by entities that manage policies for and/or operation of data processing systems 100.

Returning to the drone example, at least one inference model may be used to generate predictions regarding occurrences of states (e.g., including any number of events) which may impact the ability of the drones to provide the agriculture management services. For example, the inference model(s) may generate predictions regarding likelihoods that strong winds may adversely affect the drones’ ability to spray pesticide over a crop when operating at velocities defined by a nominal flight policy (e.g., the nominal flight policy may include flight patterns that are appropriate in low wind conditions). Therefore, the predictions may indicate that the drones may experience a damaged state and/or may be unable to properly distribute the pesticide over the crop if deployed in the strong winds based on the low wind flight pattern.

Therefore, the inference model(s) may be prompted to run multiple simulations using various flight patterns (e.g., ingest data describing different velocity information than what is defined by the nominal flight policy). For example, a test flight pattern may instruct the drones to fly into the direction of the strong winds at higher speeds than nominal, instead of a crosswind flight pattern defined by the nominal flight policy). Based on each test flight pattern, dependent future events (e.g., usable to define future states) may be predicted for the drones. For example, the drones may be predicted to have difficulty changing direction at edges of the crop under strong wind conditions and/or the drones may be predicted to perform the services at varying levels of cost efficiency (e.g., the drones may operate in a time inefficient state, in a high energy utilization state, in a high risk (of damage) state).

As a result, the inference model(s) may generate predictions regarding a large number of future events over time (e.g., relating to each test flight pattern scenario), and some of the predicted future events may be dependent on other (preceding) predicted future events. To properly consider (e.g., measure) effects and/or outcomes of each test flight pattern, the large number of predicted future events may be reduced in size (e.g., via clustering of future events) and may be represented using an acyclic graph.

In general, embodiments disclosed herein may provide methods, systems, and/or devices for managing operation of data processing systems based on predicted future states for the data processing systems. To do so, a plurality of predictions may be generated using at least one inference model trained to predict future states for the data processing systems. The plurality of predictions may be time-dependent, and therefore may be analyzed in aggregate (e.g., within a time period) using statistical techniques to obtain statistical characterizations (e.g., ratio, mean, median, mode, standard deviation). The statistical characterizations may be used to define clusters (e.g., group predicted future states generated due to a statistical variance in the predictions).

To improve analysis and/or interpretation of the plurality of predictions and statistical characterizations thereof, the clusters (e.g., predicted future states) may be represented using an acyclic (temporal) graph. Based on the statistical characterizations, the acyclic graph may provide for context when interpreting likelihoods of the data processing systems experiencing the predicted future states. The acyclic graph may be analyzed in view of operational goals for the data processing systems in order to define (e.g., created, update, supersede) policies that define operation of the data processing systems. Doing so may increase a likelihood of avoiding occurrences of predicted future states associated with negative outcomes and/or may increase a likelihood of promoting occurrences of predicted future states associated with positive outcomes.

By doing so, a system in accordance with an embodiment may be used to manage policy definition for data processing systems in a manner that provides context (e.g., explainability) to predicted future states of the data processing systems. By analyzing clusters of predictions using the acyclic graph, policies may be dynamically generated and/or updated. In addition, action sets performed based on the dynamic policies may be implemented to manage operation of the data processing systems in a manner that increases a likelihood of the data processing systems providing the computer-implemented services as desired.

To perform the above-noted functionality, the system of FIG. 1 may include data processing systems 100, and/or management system 102. Data processing systems 100, management system 102, and/or any other type of device not shown in FIG. 1 may perform all, or a portion of, the computer-implemented services independently and/or cooperatively. Each of these components is discussed below.

Data processing systems 100 may include any number and/or type of data processing systems (e.g., 100A-100N), which may include any number of hardware and/or software components configured to provide computer-implemented services. While providing the computer-implemented services, data processing systems 100 may generate data, such as telemetry data, performance data, sensor data, and/or other data related to operation of data processing systems 100. The data generated by data processing systems 100 may be provided to management system 102, which may provide device management services for data processing systems 100. For example, the data provided to management system 102 by data processing systems 100 may include training data usable to train inference models managed by management system 102 and/or input data usable as ingest for inference models managed by management system 102.

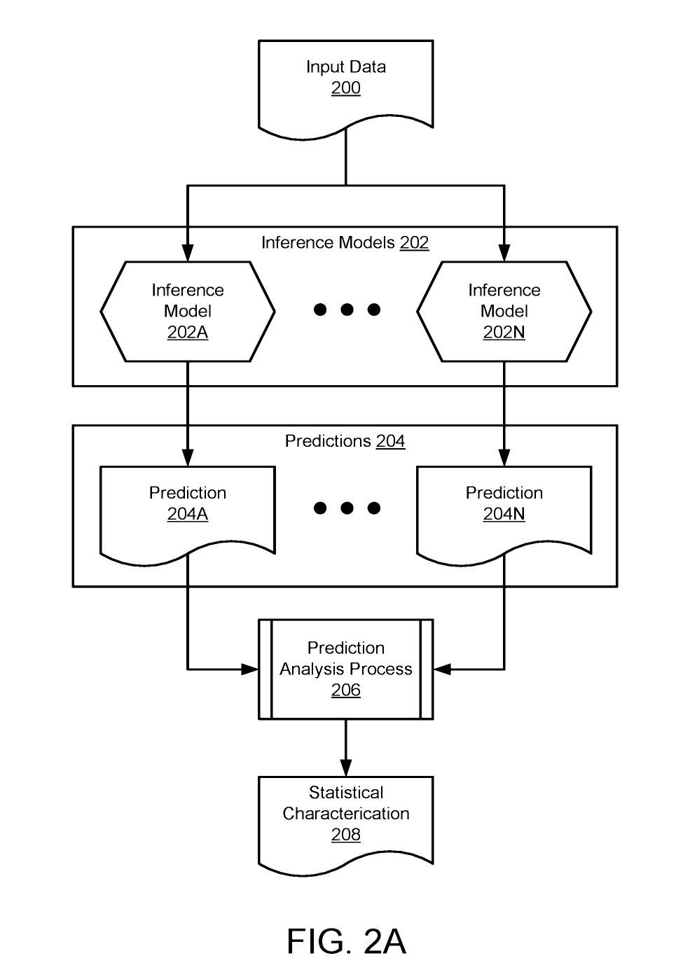

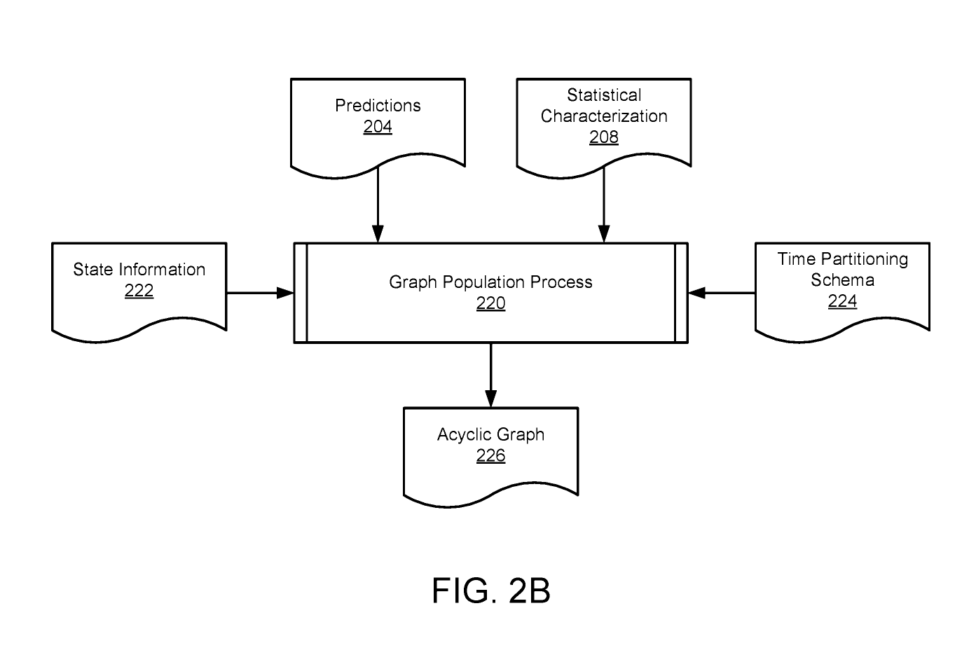

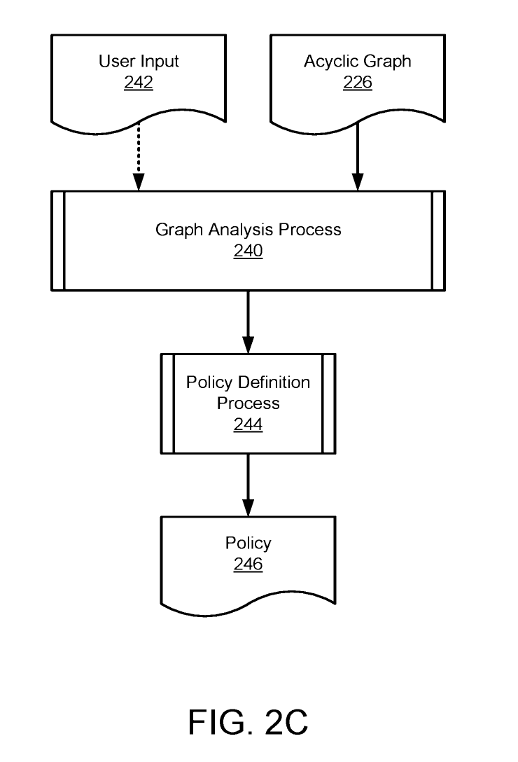

Management system 102 may include any number and/or type of devices (e.g., other data processing systems, servers, storage devices, user devices) that may be used to provide the device management services. As part of providing the device management services, management system 102 may manage (e.g., train and/or host) any number and/or type of inference models. For example, management system 102 may (i) obtain data (e.g., from data processing systems 100, from other data sources) such as training data and/or input (e.g., ingest) data for inference models, (ii) process the data (e.g., data interpolation, extraction, transformation), (iii) train any number of inference models (e.g., to predict future states for data processing systems 100) using the training data, (iv) generate a plurality of predictions (e.g. using the input data) regarding future states for data processing systems 100 (e.g., including events that may occur at any future point in time, over a duration of time beginning at a future point in time), and/or (v) analyze the predictions using statistical techniques (e.g., to obtain statistical characterizations for the predictions). For more information regarding management of inference models and inference model predictions, refer to the discussion of FIG. 2A.

To perform device management services related to policy management for data processing systems 100, management system 102 may (i) obtain (e.g., populate) acyclic graphs representing the predictions and/or statistical characterizations thereof, (ii) facilitate analysis of the acyclic graphs (e.g., by a user or other entity) so that policies for data processing systems 100 may be defined based on the analysis, and/or (iii) perform other actions for managing operation of data processing systems 100 (e.g., initiate and/or perform action sets associated with the policies). The policies may define how data processing systems 100 are to operate in view of operational goals (e.g., operational goals for data processing systems 100, operational goals that relate to the computer-implemented services provided by data processing systems 100).

For example, to obtain the acyclic graphs, management system 102 may perform graph population processes using statistical characterizations for the plurality of predictions in order to define clusters of the predicted future states. The clusters may represent predicted future events that are considered same or similar (e.g., based on the statistical characterizations and criteria for clustering), and that define predicted future states. By doing so, a reduced size representation of the plurality of predictions may be obtained to improve clarity during analysis of potential future states. Management system 102 may use the clusters and/or other information (e.g., likelihoods of event occurrences based on the statistical characterizations, outcome information) to obtain the acyclic graphs. For more information regarding obtaining acyclic graphs, refer to the discussion of FIG. 2B.

To facilitate analysis of the acyclic graphs for improved policy definition, management system 102 may perform graph analysis processes using the acyclic graphs and/or user input (or input from other devices when analysis is automated). For example, a user may be presented with an acyclic graph through an interactive graphical user interface (GUI) that allows the user to analyze the clusters over time (e.g., streams of future predicted states of the acyclic graph). During this analysis of the acyclic graph, parameters (e.g., constraints) for policy definition may be determined. The policies may be defined to guide operation of data processing systems 100 in a manner that is more likely to achieve operational goals. For more information regarding policy definition using acyclic graphs, refer to the discussion of FIG. 2C.

Thus, device management services for data processing systems 100 may be provided by management system 102. By doing so, a plurality of predictions generated by the inference model(s) may be analyzed using various statistical techniques in order to populate an acyclic graph usable for policy management. Based on an analysis of the acyclic graph, policies for data processing systems 100 may be defined (e.g., existing policies updated and/or new policies created) for use in managing operation of data processing system 100. For example, remedial actions may be performed as defined by the policies in order to manage effects of undesired outcomes associated with predicted future states for the data processing system. As a result, the provided computer-implemented services may be more reliable and less likely to be interrupted and/or delayed.

When providing their functionality, any of data processing systems 100, and/or management system 102 may perform all, or a portion, of the processes, interactions, and methods illustrated in FIGS. 2A-4.

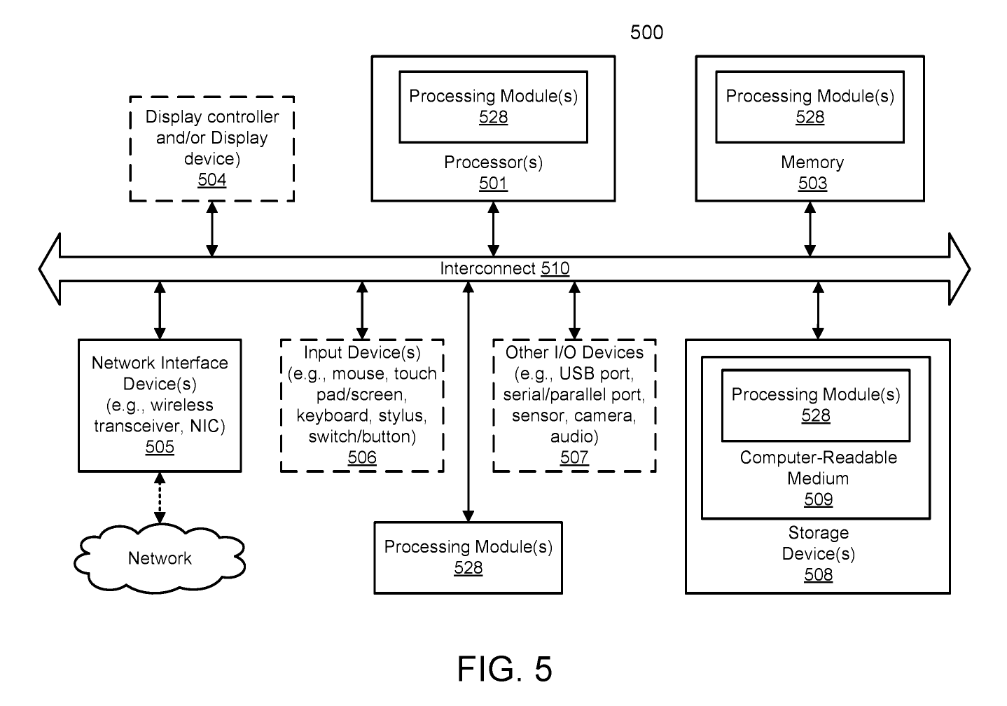

Any of data processing systems 100 and/or management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), and edge device, an embedded system, local controllers, an edge node, and/or any other type of data processing device or system. For additional details regarding computing devices, refer to FIG. 5.

Any of the components illustrated in FIG. 1 may be operably connected to each other (and/or components not illustrated) with communication system 104. Communication system 104 may facilitate communications between the components of FIG. 1. In an embodiment, communication system 104 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein. For example, while the system of FIG. 1 shows a single management system (e.g., 102), it will be appreciated that the system may include any number of management systems.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 200, 208) is used to represent data structures, a second set of shapes (e.g., 206, 220) is used to represent processes performed using and/or that generate data, and a third set of shapes (e.g., 202A, 202N) is used to represent inference models.

Turning to FIG. 2A, a first data flow diagram in accordance with an embodiment is shown. The first data flow diagram may illustrate data used in and data processing performed in obtaining statistical characterizations for a plurality of predictions generated using at least one inference model.

To obtain a statistical characterization, input data 200 may be used as ingest to generate predictions using inference models 202. Inference models 202 may be hosted by a management system (e.g., management system 102, not shown) responsible for managing operation of data processing systems used to provide computer-implemented services (e.g., data processing systems 100, not shown). Input data 200 may include any type and/or quantity of data, including data generated by data processing systems 100 (e.g., collected using sensors, telemetry data, performance data) and/or data from any other data source (e.g., databases, other management systems, other data processing systems).

Input data 200 may be provided to inference models 202 and used as ingest to generate predictions. Inference models 202 may include any type (e.g., machine learning, decision tree, quantile regression, deterministic simulation, computationally driven simulation, dynamic simulation, analytical simulation) and/or any quantity of inference models (e.g., 202A-202N). Inference models 202 may be trained using training data which defines goals for predictions made by the inference models. Parameters of the inference models may be selected using an optimization process (e.g., an objective function may be defined in terms of the training data and predictions made by the inference models, and a global optimization method such as gradient descent may be used to identify parameters that most faithfully reproduce the trends in the training data).

Once the parameters of an inference model (e.g., inference model 202A) are set, then the inference model may be used to make predictions. A single inference model (e.g., 202A) may be used to generate predictions and/or a plurality of inference models (e.g., 202A-202N) may be used to generate predictions. Differences in model type, training data, and/or the optimization process may result in variability between the predictions made by the inference models, even when the predictions are generated using the same (and/or substantially the same) input dataset. Additionally, stochastic elements (e.g., random variance in one or more parameters over time) may result in prediction variability (e.g., within a single model and/or simulation) for a given set of conditions.

The input dataset used as ingest for inference models 202 (e.g., input data 200) to generate predictions may be substantially the same for each prediction. For example, substantially the same input data may include criteria which permit up to a 10% difference in the input data (e.g., at least 90% of the input data is the same). In a second example, the criteria may indicate that the input data may only differ by 5% to be considered substantially the same (e.g., at least 95% of the input data is the same). In a third example, the criteria may indicate that the input data may differ by 25% to be considered substantially the same (e.g., at least 75% of the input data is the same).

Input data 200 may be ingested by inference models 202, and predictions 204 may be generated as output. Predictions 204 may include a plurality of predictions (e.g., 204A-204N) generated by respective inference models that each predict occurrence of a future state (e.g., a state that may occur at any future point in time, over a duration of time beginning at any future point in time). For example, predictions 204 may include predictions regarding states which may impact the operation of data processing systems 100, including events such as changes in temperature, resource availability (e.g., forecasted changes in power supply and/or demand), weather conditions (e.g., rain, hail, wind), and/or any other events which may impact the devices.

For example, data processing systems 100 may include edge devices managed by management system 102, which may include smart streetlights in a region. The smart streetlights may be implemented to conserve power by adjusting the amount of light generated based on data collected by sensors. The data collected by the sensors may include data regarding brightness, humidity, motion, temperature, etc. The data may be provided to management system 102 and used, at least in part, as input data for a plurality of inference models used to generate predictions regarding the occurrence of events which may impact the operation of the smart streetlights.

The plurality of predictions (e.g., predictions 204A-204N) may be used to perform prediction analysis process 206. During prediction analysis process 206, predictions 204 may be analyzed in aggregate to obtain a statistical characterization (e.g., statistical characterization 208) regarding agreement in the plurality of predictions. The statistical characterization may be obtained using any type and/or quantity of statistical methods (e.g., techniques, calculations, data fitting), including averaging, population distribution calculations, hypothesis testing, regression, analysis of variance, and/or any other type of statistical methods. The statistical characterization may include a ratio, mean, median, mode, and/or standard deviation for predictions 204.

Continuing with the above example, the plurality of inference models may generate predictions based on the sensor data and/or data from other sources regarding an increase in temperature which may affect operation of 100 smart streetlights (e.g., the operation may be impacted to an undesirable degree if the operation continues in the current operating state). For example, temperature data collected by the sensors and temperature data collected from weather satellites may be used as input data for 20 inference models. Of the 20 inference models, 5 may generate predictions indicating the temperature will affect operation of 60 smart streetlights, 10 may generate predictions indicting the temperature will affect operation of 80 smart streetlights, 3 may generate predictions indicating the temperature will affect operation of 75 smart streetlights, and 2 may generate predictions indicting the temperature will affect operation of 10 smart streetlights.

A prediction analysis process may be used to analyze the predictions using statistical methods to obtain statistical characterizations such as a median (e.g., 77.5 smart streetlights will be affected) and a standard deviation (e.g., 21.3 smart streetlights).

Statistical characterization 208 may include any number of statistical characterizations for the predictions. For example, the statistical characterizations may be used to define clusters of future predicted events over defined periods of time (e.g., based on levels of agreement of the predicted future events within the defined periods of time and criteria associated with quantities of the statistical characterizations). The clusters may represent predicted future states as defined by the future predicted events, and the statistical characterizations may be used to quantify likelihoods of transitions between the predicted future states.

Thus, by implementing the data flow shown in FIG. 2A, a system in accordance with embodiments disclosed herein may be used to obtain statistical characterizations for a plurality of predictions generated by at least one inference model. The statistical characterizations may indicate variability in the predictions, and may be used to prepare the prediction data for further analysis.

While described herein as the inference model(s) generating predictions regarding occurrences of future states for a data processing system, it may be appreciated that the inference model(s) may generate predictions regarding future events and/or other conditions for the data processing system, which may be usable to define operational states for the data processing system.

Turning to FIG. 2B, a second data flow diagram in accordance with an embodiment is shown. The second data flow diagram may illustrate data used in and data processing performed in obtaining an acyclic graph based on a plurality of predictions and statistical characterizations for the plurality of predictions.

To obtain the acyclic graph, graph population process 220 may be performed. During graph population process 220, predictions 204, statistical characterization 208, state information 222 and/or time partitioning schema 224 may be used to obtain acyclic graph 226.

For example, predictions 204 may include a plurality of predictions obtained using at least one inference model trained to predict future states for a data processing system over time (e.g., as described with respect to FIGS. 1-2A). Predictions 204 may include dependent (e.g., temporally dependent) predicted future states for the data processing system. For example, occurrences of some portions of predictions 204 may depend on prior occurrences of other portions of predictions 204.

Predictions 204 may include temporal elements. For example, portions of predictions 204 (e.g., a predicated future event for the data processing system) may be associated with a future point in time and/or a duration of time). To analyze predictions 204 with respect to time, predictions 204 may be partitioned into time periods (or points in time) using time partitioning schema 224. Time partitioning schema may include information usable to define time points and/or time periods for acyclic graph 226. Time partitioning schema 224 may be predetermined, may be customizable (e.g., by a user), and/or may be determined based on time information of predictions 204.

Once predictions 204 are partitioned by time, during graph population process 220, predicted future states may be obtained. To do so, graph population process 220 may include a clustering process for predictions 204. The clustering process may be performed using any type of clustering algorithm (e.g., k-means clustering, mean-shift clustering, rule-based clustering) and/or statistical characterization 208. As discussed with respect to FIG. 2A, statistical characterization 208 may include different types of statistical characterizations for predictions 204. For example, the clustering algorithm may use any of the different types of statistical characterizations of predictions 204 to define clusters of predicted future events for each time partition.

The clusters may, for example, be defined based on similar and/or same predicted future events for the data processing system (e.g., similarity being based on some criteria corresponding to quantities of any of statistical characterization 208). The predicted future events of each cluster may be used to define a predicted future state. For example, if events of a cluster include failure of a crucial hardware component of the data processing system (e.g., a motherboard), then data processing system may be in a non-operational state during the time period or at the time point for which the cluster is defined. Therefore, each cluster may indicate a predicted future state for the data processing system.

State information 222 may include information regarding a current state of the data processing system and/or other information regarding other types of (e.g., predefined) states for the data processing system. For example, state information 222 may include specific outcomes associated with operational states for the data processing system, levels of severity of the outcomes, levels of priority for administrator intervention, and/or other information regarding the operational states.

State information 222 may be used, along with other data, to populate metadata for each cluster. For example, a cluster indicating a non-operational state for the data processing system may be associated with a negative outcome (e.g., unable to provide computer-implemented services) and a level of priority indicating immediate administrator attention is required. Or, for example, a cluster indicating that the data processing system is operating in a high-capacity state (e.g., the data processing system is operating at or near capacity limits of portions of its hardware resources) may be associated with a positive outcome (e.g., the computer-implemented services are lucrative) and a level of priority indicating administrator attention is required within a specified period of time, although not immediately.

Metadata for each cluster may include, for example, (i) information regarding the predicted future state (e.g., severity levels, positive/negative outcomes), (ii) whether policies are keyed to the predicted future state, (iii) a number of simulations and/or inference models that predicted the future events included in the cluster, (iv) information regarding variability in predicted future states (e.g., time partitioned groups of predictions), and/or (v) any other data associated with the cluster (e.g., from state information 222, predictions 204, statistical characterization 208, and/or time partitioning schema 224).

For example, data from state information 222, predictions 204, statistical characterization 208, time partitioning schema 224, and/or other data structures or sources may be input to an inference model such as a large language model (LLM) for summarization and/or interpretation. Thus, the metadata for each cluster may include human interpretable text generated by an LLM.

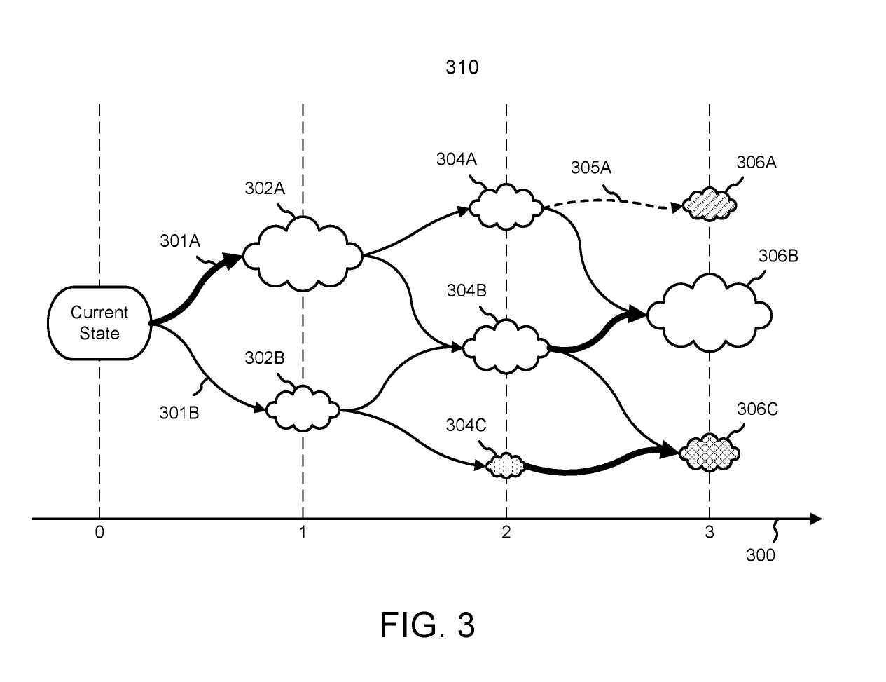

Acyclic graph 226 may include a plurality of nodes connected by a plurality of edges. For example, the nodes may represent the clusters of the predicted future states, and the clusters may be connected by edges based on their dependencies. The edges may indicate temporally dependent relationships between the clusters and/or other types of relationships such as likelihoods of transitions between occurrences of the predicted future states of the clusters of the time partitions. An example of an acyclic graph that may be obtained during graph population process 220 is shown in FIG. 3.

Turning to FIG. 3, an example of an acyclic graph is shown in accordance with an embodiment. FIG. 3 shows directed acyclic graph 310 that includes a plurality of nodes (e.g., 302A-306A, 302B-306B, 304C-306C) represented by a cloud shape, and some of the nodes are connected by a plurality of edges (e.g., 301A, 305A, 301B) represented using arrows. Each of the nodes may represent clusters of predicted future states for the data processing system. Each of the edges connecting the nodes may represent relationships between the clusters (e.g., relationships based on metadata of the clusters). For example, the arrows may indicate directional dependencies (e.g., order in a time series of predicted states). For practical purposes, while describing FIG. 3 the nodes may be referred to as predicted (future) states. For example, node 302A may be referred to as predicted state 302A.

The predicted states for the data processing system may be arranged over time (e.g., in accordance with their time partition) on a horizontal time axis with time increasing to the right, as indicated by arrow 300. Along the horizontal time axis are simulated time periods/points/steps (e.g., 0, 1, 2, 3) corresponding to the time partitioned predicted states, with time period 0 being a present time (e.g., a current state of operation of the data processing system as indicated by input data used to generate acyclic graph 310, such as state information 222). Dashed vertical lines ascending from each time period/point/step of the horizontal time axis are shown intersecting corresponding predicted states.

Directed acyclic graph 310 may define streams of predicted states. The streams may include states that are predicted to occur in a series over time. For example, a first stream may be defined from the current state via arrows (e.g., edges) connecting predicted state 302A, predicted state 304A, and predicted state 306B, and a second stream may be defined from the current state via arrows connecting predicted state 302B, predicted state 304B, and predicted state 306B. Each stream may include an upstream predicted state and a downstream predicted state, where the downstream predicted state is predicted to occur after the upstream state occurs. In other words, the occurrence of the downstream state may be dependent on an occurrence of the upstream state.

For example, the data processing system may be operating in accordance with nominal operating standards in its current state. However, it may be predicted that, at time point 1, the data processing system will experience a heavy workload (e.g., predicted state 302A may include a high workload state where the data processing system is experiencing workloads that exceed maximum capacities for its hardware and/or software components). Given that the data processing system may be operating in predicted state 302A, it may be predicted that, due to cooling hardware age and/or performance metrics, the data processing system may be likely to experience temperatures that exceed nominal operating temperatures for the data processing system at time point 2 while in predicted state 304A (e.g., predicted state 304A may include an overheating state and may include cooling hardware failure event).

If the data processing system is left to operate in predicted state 304A for a given period of time (e.g., indicated by the horizontal axis and/or by metadata of predicted state 304A), then data processing system may experience predicted state 306A, which may include additional hardware failure events which may be catastrophic to the operation of the data processing system. For example, predicted state 306A may include a non-operational state for data processing system and/or may be associated with negative outcomes such as data loss and/or significant reduction in quality of provision of computer-implemented services.

Therefore, with respect to the stream described in the above example, predicted state 306A may occur downstream of upstream predicted states 304A and 302A, and the occurrence of predicted state 306A may depend on at least one of upstream predicted states 304A and 302A occurring.

Turning to FIG. 2C, a third data flow diagram in accordance with an embodiment is shown. The third data flow diagram may illustrate data used in and data processing performed during analysis of an acyclic graph (e.g., acyclic graph 226).

To analyze acyclic graph 226, graph analysis process 240 may be performed. During graph analysis process 240, streams of clusters may be identified and analyzed in order to identify needs for policy management. The streams (e.g., clusters thereof) may be associated with future outcomes (e.g., based on metadata for each cluster) for the data processing system. The future outcomes may include desired future outcomes or undesired future outcomes, defined in accordance with an operational goal for the data processing system.

To manage future outcomes (e.g., to avoid the undesired future outcomes and/or to promote the desired future outcomes), existing policies keyed to known operating states for the data processing system may be in place. However, in some cases, existing policies may require updates and/or new policies may need to be created in order to manage operating states that are not associated with adequately defined policies (e.g., previously unknown or new operating states). Therefore, streams of predicted future states that are not adequately managed by policies may be identified during graph analysis process 240.

In a first example, a stream of acyclic graph 226 may be identified. The stream may include a downstream cluster indicating a predicted future state for the data processing system that is associated with an undesired future outcome for the data processing system. The downstream cluster may not be adequately managed by a policy. For example, the downstream cluster may not be associated with a policy, or the downstream cluster may not be associated with a policy that, when invoked, reduces a likelihood of occurrence of predicted future events of the downstream cluster. Therefore, the downstream cluster may be identified for policy management during graph analysis process 240.

Continuing with the first example, an upstream cluster of the stream may be identified. Predicted future events of the upstream cluster may be predicted to occur prior to predicted future events of the downstream cluster. Therefore, to prevent occurrence of predicted future events of the downstream cluster, the upstream cluster may be identified for policy management (e.g., if the upstream cluster is not adequately managed by a policy). For example, a policy may be defined so that a likelihood of an occurrence of predicted future events of the upstream cluster is reduced while the policy is enforced.

In a second example, a stream of acyclic graph 226 may be identified. The stream may include a downstream cluster indicating a predicted future state for the data processing system that is associated with a desired future outcome for the data processing system. If the downstream cluster is not adequately managed by a policy that increases a likelihood of occurrence of predicted future events of the downstream cluster, then the downstream cluster may be identified for policy management. In addition, to further increase the likelihood of the occurrence of the predicted future events of the downstream cluster, then an upstream cluster of the stream that is not adequately managed by a policy may be identified for policy management during graph analysis process 240. For example, a policy may be defined so that a likelihood of an occurrence of predicted future events of the upstream cluster is not reduced (e.g., increased) while the policy is enforced.

During graph analysis process 240, acyclic graph 226 may be analyzed by a user. The user may include a user tasked with managing operation of the data processing system. Therefore, user input 242 may be provided to graph analysis process 240. For example, acyclic graph 226 may be displayed to the user via a GUI that may be browsed, and interacted with. Acyclic graph 226 may be displayed via the GUI as shown in FIG. 3.

Returning to FIG. 3, a user interface displaying directed acyclic graph 310 may illustrate streams of predicted future states for the data processing system over time, the streams indicating where different streams converge and diverge. For example, a first stream defined by the current state and predicted states 302A, 304B and 306B may converge and diverge with a second stream defined by the current state and predicted states 302B, 304B, and 306C (e.g., at predicted state 304B). The user interface may also indicate likelihoods of the different streams occurring.

To improve interpretability by the user, the edges (e.g., arrows) of directed acyclic graph 310 may be drawn in varying thicknesses and/or line styles to signify different types of metadata, such as likelihoods of transitions between predicted states. The likelihoods may be based on probabilities of occurrences of the predicted states (e.g., distributions of the predicted states). For example, an edge between an upstream predicted state and a downstream predicted state may indicate a ratio of a number of simulations that contributed to the upstream predicted state to a number of the simulations that also contributed to the downstream predicted state. The distribution of numbers of simulations contributing to different predicted states may indicate likelihoods of occurrences of the different predicted states. The likelihoods may be associated with different drawing styles based on predefined thresholds.

For example, edge 305A drawn in dashing may indicate that a likelihood of predicted future events of predicted state 306A occurring after predicted future events of predicted state 304A is low (e.g., less than 10% likely), whereas edge 301A drawn using a thick line may indicate that a likelihood of predicted future events of predicted state 302A occurring given the current state is high (e.g., more than 90% likely). Similarly, edge 301B drawn using a thin line may indicate that a likelihood of predicted future events of predicted state 302B occurring given the current state is moderate (e.g., between 10% and 90% likely).

Nodes (e.g., predicted states) of directed acyclic graph 310 may be sized based on statistical characterizations 208 and/or other metadata of the predicted states (e.g., based on predefined and/or customizable settings). For example, node size may indicate a number of simulations (e.g., predictions) that contributed to the cluster (e.g., a number of the predictions that indicate that a particular state is predicted to occur) thereby indicating a likelihood that the state associated with the cluster may occur. The nodes may be sized, colored, or patterned to visually communicate metadata to the user based on sets of rules and/or thresholds (e.g., alerts settings for specified ranges of metadata values).

For example, predicted state 306A may be patterned to indicate that predicted state 306A is not adequately managed by a policy, predicted state 306A may be patterned to indicate that predicted state 306C is associated with a negative outcome in view of operational goals, and/or predicted state 304A may be patterned to indicate that a policy keyed to predicted state 304A requires review. Therefore, the user may interact (e.g., click on) node 306A to obtain more information (e.g., metadata) and/or to identify (e.g., flag) predicted state 306A for policy management. For example, metadata for each cluster (e.g., predicted state) may include information regarding variability in predictions for each time partition of acyclic graph 310 (e.g., a standard deviation for all of the predictions partitioned into time point 1).

The user may provide user input (e.g., user input 242) while interacting with the GUI. For example, the user may provide input indicating that a stream of directed acyclic graph 310 violates an operational goal for the data processing system. The user input provided by the user may be responsive to at least one prompting by the GUI. For example, the user input may be provided based on node sizes, colors or patterns, and/or textual information associated with the nodes or edges of directed acyclic graph 310 that may indicate user intervention (e.g., input) is required. The user input may be used, at least in part, to define a policy for the data processing system.

Returning to FIG. 2C, once streams and/or clusters of acyclic graph 226 have been identified for policy management (e.g., by a user or other entity such as an automated analysis system), policy definition process 244 may be performed.

During policy definition process 244, policies may be defined based on streams and/or clusters of acyclic graph 226 that may violate operation goals of the data processing system. For example, the policies may be created, updated, and/or superseded using parameters and/or constraints obtained based on metadata of the identified streams and/or clusters of acyclic graph 226. During policy definition process 244, policy 246 may be defined. Policy 246 may, for example, be keyed to a state represented by a cluster identified as violating the operational goals for the data processing system and/or an upstream cluster thereof. Policy 246 may define actions for mitigating an occurrence of the state to which it is keyed and/or any other state predicted to occur thereafter.

For example, the policies defined during policy definition process 244 may include alerting policies defined to raise alarms when undesired predicted future states are likely (e.g., above a tolerance) for the data processing system, and/or remediation policies for managing operation of the data processing system in view of predicted future states.

Policy 246 may define how the data processing system is to operate (e.g., while in a specific state). For example, policy 246 may be defined such that likelihoods of occurrences of predicted future events of predicted future states of the data processing system are managed according to operational objectives (e.g., reduced or increased) while policy 246 is enforced. When policy 246 is enforced, operation of the data processing system may be updated in accordance with definitions of policy 246, and a computer-implemented service may be provided based on the updated operation of the data processing system.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using the data flow diagram shown in FIGS. 2B-2C, an acyclic graph representing a plurality of predicted future events for a data processing system may be used to manage operation of the data processing system using proactive policy definition in a manner that improves a likelihood of achieving operational goals for the data processing system.

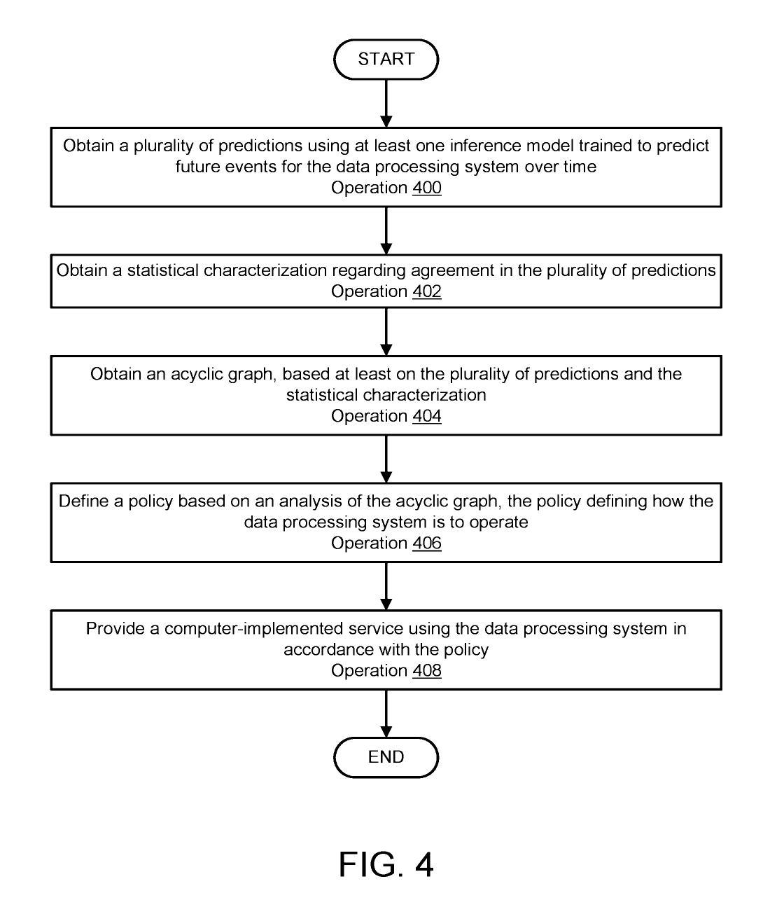

Turning to FIG. 4, a flow diagram illustrating a method in accordance with an embodiment is shown. The flow diagram may illustrate various operations performed while managing operation of a data processing system.

At operation 400, a plurality of predictions may be obtained using at least one inference model trained to predict future events for the data processing system over time. The plurality of predictions may be obtained by (i) reading the plurality of predictions from storage, (ii) receiving the plurality of predictions (e.g., from another device), (iii) generating the plurality of predictions, and/or (iv) other methods.

For example, the plurality of predictions may be generated by (i) obtaining input data, (ii) using the input data as ingest for the at least one inference model (e.g., feeding the input data into the at least one inference model to generate predictions), (iii) obtaining the plurality of predictions as output of the at least one inference model (e.g., generating the predictions by the inference model using the input data). Refer to the discussion of FIG. 2A for more details regarding obtaining a plurality of predictions.

At operation 402, a statistical characterization regarding agreement in the plurality of predictions may be obtained. The statistical characterization may be obtained by (i) reading the statistical characterization from storage, (ii) receiving the statistical characterization (e.g., from another device), (iii) generating the statistical characterization, and/or (iv) other methods.

For example, the statistical characterization may be generated by (i) aggregating the plurality of predictions into a dataset, (ii) using statistical methods to obtain the statistical characterization of the dataset, (iii) providing the dataset to another device and receiving the statistical characterization in response, and/or (iv) other methods. Using the statistical methods may include performing statistical calculations (e.g., averaging, population distribution calculations, hypothesis testing, regression, analysis of variance). For example, the statistical characterization may include a mean, median, mode, standard deviation and/or any other type of statistical characterization of the dataset usable to determine agreement in the plurality of predictions.

At operation 404, an acyclic graph may be obtained, based at least on the plurality of predictions and the statistical characterization. The acyclic graph may be obtained by performing a graph population process similar to graph population process 220 of FIG. 2B and/or by other methods. For example, obtaining the acyclic graph may include (i) defining time partitions for the acyclic graph, and for each time partition of the time partitions (ii) defining clusters of predicted future events based, in part, on the statistical characterization and criteria including requirements corresponding to quantities of the statistical characterization.

Defining the time partitions for the acyclic graph may include obtaining a time partitioning schema (e.g., from storage, from another entity) and using a time partitioning schema to separate the predicted future events by units and/or ranges of time as defined by the partitioning schema. For example, the time partitioning schema may define buckets of time (e.g., durations or points in time), and time information included in the predicted future events may be used to label each predicted future event with its corresponding bucket.

Defining clusters of predicted future events may include implementing a clustering algorithm (e.g., k-means clustering, hierarchical clustering, rule-based clustering). For example, the clustering algorithm may use the statistical characterization (e.g., any number of statistical characterizations for the plurality of inferences) to assess levels of agreement between the predicted future events corresponding to each time bucket (e.g., time partition), and may cluster the predicted future events in accordance with requirements of the criteria associated with the levels of agreement (e.g., the statistical characterization).

For example, the requirements may include thresholds for levels of agreement, and the thresholds may be used to evaluate whether predicted future states should be clustered based on values of levels of agreement when compared to the thresholds. For more details regarding defining time partitions and clustering predicted future events, refer to the discussion of FIGS. 2B-3.

Obtaining the acyclic graph may include relating future predicted states for the data processing system. For example, the clusters of predicted future events may define predicted future states for the data processing system, each cluster including metadata (e.g., information regarding the predicted future events that contribute to the cluster, policy information regarding the defined predicted future states, etc.). Therefore, the acyclic graph may be obtained by populating a template for an acyclic graph by assigning clusters as nodes of the acyclic graph, and using the metadata of each of the clusters to define relationships between the clusters (e.g., edges of the acyclic graph).

Therefore, the acyclic graph may include a plurality of nodes connected by a plurality of edges, the plurality of nodes representing predicted future states for the data processing system, and the plurality of edges representing relationships between the predicted future states, such as likelihoods of transitions between predicted future states over the defined time partitions.

The acyclic graph may define streams, the streams including future states that are predicted to occur in a series over time, and each stream of the streams including an upstream predicted future state and a downstream predicted future state, the downstream predicted future state being predicted to occur after the upstream predicted future state occurs. For example, the occurrence of the downstream predicted future state may be dependent on an occurrence of the upstream predicted future state.

At operation 406, a policy may be defined based on an analysis of the acyclic graph. The policy may be defined by performing processes similar to graph analysis process 240 and policy definition process 244 of FIG. 2C and/or by other methods. The acyclic graph may be analyzed by an automated entity (e.g., a device hosting software usable to analyze the acyclic graph) and/or by a user (e.g., an SME).

For example, defining the policy may include (i) obtaining, using the acyclic graph, a GUI illustrating streams of predicted future events, the streams indicating where different streams converge and diverge, and likelihoods of the streams occurring, (ii) presenting the GUI to a user to obtain user input, and/or (iii) populating the policy using at least the user input.

Obtaining the GUI may include (i) receiving instructions (e.g., from another entity) responsible for generating and populating the GUI, (ii) executing instructions hosted by hardware resources of a device to load software for the GUI, and/or (iii) selecting the acyclic graph (e.g., a data structure) using the GUI. Presenting the GUI to the user may include loading the selected acyclic graph to be displayed by the GUI (e.g., using a peripheral device of the device such as a monitor) and prompting the user (e.g., via a popup interface, via a message, via a notification in an application on a device) with instructions for accessing the GUI.

The user input may be obtained, for example, in response to at least one prompting by the GUI, the prompting indicating that the at least one of the streams would violate an operational goal for the data processing system. The user may provide the user input, for example, via an interaction with one or more human interface devices (e.g., a mouse, a keyboard, a touch screen) and the user input may be obtained by via interpretation of the interaction and/or via other methods. The user input may include, for example, a selected predicted future event (e.g., metadata thereof) that may be used to define the policy. For more details regarding defining the policy using the acyclic graph, refer to the discussion of FIGS. 2C-3.

In a first example, defining the policy may include (i) identifying a first downstream cluster of a first stream of the acyclic graph, the first downstream cluster being associated with an undesired future outcome for the data processing system (ii) identifying a first upstream cluster of the first stream, and/or (iii) populating the policy so that a likelihood of an occurrence of predicted future events of the first upstream cluster is reduced while the policy is enforced.

In a second example, defining the policy may include (i) identifying a second downstream cluster of a second stream of the acyclic graph, the second downstream cluster being associated with a desired future outcome for the data processing system (ii) identifying a second upstream cluster of the second stream, and/or (iii) populating the policy so that a likelihood of an occurrence of predicted future events of the second upstream cluster is not reduced while the policy is enforced.

Identifying the (first/second) downstream cluster of the (first/second) stream associated with an (undesired/desired) outcome may include querying metadata for each cluster of the acyclic graph. For example, the user may view a display of the acyclic graph (e.g., via the GUI), in which clusters of the acyclic graph are colored or patterned by outcome associated with the cluster. The user may identify the downstream cluster based on the color or pattern of the cluster and may select the downstream cluster (e.g., via an interaction with a human interface device) to obtain the metadata and/or a summary of the metadata.

Identifying the (first/second) upstream cluster of the (first/second) stream may include identifying the stream (e.g., based on metadata of each cluster and/or a visual identification). For example, the user may interact with the GUI (e.g., provide feedback in the form of instruction) to only display clusters for a particular stream (e.g., based on a stream identifier for the downstream cluster). A cluster that occurs prior to the downstream cluster (e.g., the upstream cluster) may be identified by querying metadata such as time information associated with each cluster and/or by the user viewing the time axis of the acyclic graph.

In a third example, defining the policy may include providing the acyclic graph to another entity for analysis. The entity may include a device that hosts software usable to analyze the acyclic graph. As a result of the analysis, the entity may provide information regarding clusters, streams, and/or policies (e.g., suggested parameters or constraints thereof) that require user review.

Populating the policy to manage likelihoods of occurrences of predicted future events (e.g., predicted future states) may include (i) querying metadata for any identified clusters (e.g., the upstream cluster and/or the downstream cluster), (ii) obtaining parameters and/or constraints based on the metadata (e.g., statistical characterizations of the upstream cluster), (iii) selecting a policy template keyed to the predicted future event of the upstream cluster, and/or (iii) using the parameters and/or constraints to update the policy template. For example, updating the policy template may include modifying criteria (e.g., thresholds) of the policy template and/or defining actions associated with the policy for updating operation of the data processing system. The policy may define how the data processing system is to operate when placed in the predicted state.

At operation 408, a computer-implemented service may be provided using the data processing system in accordance with the policy. For example, providing the computer-implemented service may include (i) performing functions of the data processing system in a modified state defined by the policy (e.g., at a reduced power, at a reduced processor frequency), (ii) performing the functions of the data processing system in a different location (e.g., in a location where the predicted future state is not likely to occur), (iii) performing the functions of the data processing system at a different time (e.g., before and/or after a time range associated with the predicted future state), and/or (iv) other methods.

The method may end following operation 408.

Thus, as illustrated above, embodiments disclosed herein may provide systems and methods usable to manage policy definition for a data processing system based on acyclic graph populated using predictions regarding future states of the data processing system. By doing so, the policies may be managed so that operational objectives for the data processing system are more likely to be met, and operation of the data processing systems may be updated in accordance with the policies to hedge against a risk of undesired outcomes associated with predicted future states.

Any of the components illustrated in FIGS. 1-3 may be implemented with one or more computing devices. Turning to FIG. 5, a block diagram illustrating an example of a data processing system (e.g., a computing device) in accordance with an embodiment is shown. For example, system 500 may represent any of data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high-level view of many components of the computer system. However, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 501, memory 503, and devices 505-507 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like. More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system on chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in one embodiment can be implemented via multiple memory devices to provide for a given amount of system memory. Memory 503 may include one or more volatile storage (or memory) devices such as random-access memory (RAM), dynamic RAM (DRAM), synchronous DRAM (SDRAM), static RAM (SRAM), or other types of storage devices. Memory 503 may store information including sequences of instructions that are executed by processor 501, or any other device. For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows^{®} operating system from Microsoft^{®}, Mac OS^{®}/iOS^{®} from Apple, Android^{®} from Google^{®}, Linux^{®}, Unix^{®}, or other real-time or embedded operating systems such as VxWorks.

System 500 may further include IO devices such as devices (e.g., 505, 506, 507, 508) including network interface device(s) 505, optional input device(s) 506, and other optional IO device(s) 507. Network interface device(s) 505 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs, or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
obtaining a plurality of predictions using at least one inference model trained to predict future states for the data processing system over time;
obtaining a statistical characterization regarding agreement in the plurality of predictions;
obtaining an acyclic graph, based at least on the plurality of predictions and the statistical characterization;
defining a policy based on an analysis of the acyclic graph, the policy defining how the data processing system is to operate; and
providing a computer-implemented service using the data processing system in accordance with the policy.

2. The method of claim 1, wherein obtaining the acyclic graph comprises:
defining time partitions for the acyclic graph; and
for each time partition of the time partitions:
defining clusters of predicted future states based, in part, on the statistical characterization and criteria comprising requirements corresponding to quantities of the statistical characterization.

3. The method of claim 2, wherein the acyclic graph comprises a plurality of nodes connected by a plurality of edges, the plurality of nodes representing the clusters of the predicted future states, the plurality of edges representing relationships between the clusters, and the relationships indicating likelihoods of transitions between occurrences of the predicted future states of the clusters over the time partitions.

4. The method of claim 3, wherein the acyclic graph defines streams, the streams comprising the clusters of the predicted future states that are predicted to occur in a series over time, and each stream of the streams comprising an upstream cluster and a downstream cluster, the downstream cluster being predicted to occur after the upstream cluster occurs.

5. The method of claim 4, wherein an occurrence of the downstream cluster is dependent on an occurrence of the upstream cluster.

6. The method of claim 5, wherein defining the policy comprises:
identifying a first downstream cluster of a first stream of the acyclic graph, the first downstream cluster being associated with an undesired future outcome for the data processing system;
identifying a first upstream cluster of the first stream; and
populating the policy so that a likelihood of an occurrence of predicted future states of the first upstream cluster is reduced while the policy is enforced.

7. The method of claim 5, wherein defining the policy comprises:
identifying a second downstream cluster of a second stream of the acyclic graph, the second downstream cluster being associated with a desired future outcome for the data processing system;
identifying a second upstream cluster of the second stream; and
populating the policy so that a likelihood of an occurrence of predicted future states of the second downstream cluster is not reduced while the policy is enforced.

8. The method of claim 1, wherein the statistical characterization comprises at least one quantity selected from a group consisting of:
a ratio;
a mean;
a median;
a mode; and
a standard deviation.

9. The method of claim 1, wherein defining the policy comprises:
obtaining, using the acyclic graph, a graphical user interface illustrating streams of predicted future states, the streams indicating where different streams converge and diverge, and likelihoods of the streams occurring;
presenting the graphical user interface to a user to obtain user input; and
populating the policy using at least the user input.

10. The method of claim 9, wherein the user input is responsive to at least one prompting by the graphical user interface, the prompting indicating that at least one of the streams would violate an operational goal for the data processing system.

11. A non-transitory machine-readable medium having instructions stored therein, which when executed by a processor, cause the processor to perform operations for managing operation of a data processing system the operations comprising:
obtaining a plurality of predictions using at least one inference model trained to predict future states for the data processing system over time;
obtaining a statistical characterization regarding agreement in the plurality of predictions;
obtaining an acyclic graph, based at least on the plurality of predictions and the statistical characterization;
defining a policy based on an analysis of the acyclic graph, the policy defining how the data processing system is to operate; and
providing a computer-implemented service using the data processing system in accordance with the policy.

12. The non-transitory machine-readable medium of claim 11, wherein obtaining the acyclic graph comprises:
defining time partitions for the acyclic graph; and
for each time partition of the time partitions:
defining clusters of predicted future states based, in part, on the statistical characterization and criteria comprising requirements corresponding to quantities of the statistical characterization.

13. The non-transitory machine-readable medium of claim 12, wherein the acyclic graph comprises a plurality of nodes connected by a plurality of edges, the plurality of nodes representing the clusters of the predicted future states, the plurality of edges representing relationships between the clusters, and the relationships indicating likelihoods of transitions between occurrences of the predicted future states of the clusters over the time partitions.

14. The non-transitory machine-readable medium of claim 13, wherein the acyclic graph defines streams, the streams comprising the clusters of the predicted future states that are predicted to occur in a series over time, and each stream of the streams comprising an upstream cluster and a downstream cluster, the downstream cluster being predicted to occur after the upstream cluster occurs.

15. The non-transitory machine-readable medium of claim 14, wherein an occurrence of the downstream cluster is dependent on an occurrence of the upstream cluster.

16. A data processing system, comprising:
a processor; and
a memory coupled to the processor to store instructions, which when executed by the processor, cause the processor to perform operations, the operations comprising:
obtaining a plurality of predictions using at least one inference model trained to predict future states for the data processing system over time,
obtaining a statistical characterization regarding agreement in the plurality of predictions,
obtaining an acyclic graph, based at least on the plurality of predictions and the statistical characterization,
defining a policy based on an analysis of the acyclic graph, the policy defining how the data processing system is to operate, and
providing a computer-implemented service using the data processing system in accordance with the policy.

17. The data processing system of claim 16, wherein obtaining the acyclic graph comprises:
defining time partitions for the acyclic graph; and
for each time partition of the time partitions:
defining clusters of predicted future states based, in part, on the statistical characterization and criteria comprising requirements corresponding to quantities of the statistical characterization.

18. The data processing system of claim 17, wherein the acyclic graph comprises a plurality of nodes connected by a plurality of edges, the plurality of nodes representing the clusters of the predicted future states, the plurality of edges representing relationships between the clusters, and the relationships indicating likelihoods of transitions between occurrences of the predicted future states of the clusters over the time partitions.

19. The data processing system of claim 18, wherein the acyclic graph defines streams, the streams comprising the clusters of the predicted future states that are predicted to occur in a series over time, and each stream of the streams comprising an upstream cluster and a downstream cluster, the downstream cluster being predicted to occur after the upstream cluster occurs.

20. The data processing system of claim 19, wherein an occurrence of the downstream cluster is dependent on an occurrence of the upstream cluster.
